(19) United States
(12) Patent Application Publication
(10) Pub. No.: US 2024/0343240 A1
(43) Pub. Date: Oct. 17, 2024

(54) A METHOD FOR RELEASING ELECTROMECHANICAL BRAKES, A MOBILE ENERGY STORAGE DEVICE FOR RELEASING THE ELECTROMECHANICAL BRAKES, AND A SYSTEM OF THE MOBILE ENERGY STORAGE DEVICE AND A BRAKE SYSTEM OF A TRAIN

(71) Applicant: KNORR-BREMSE SYSTEME FÜR SCHIENENFAHRZEUGE GMBH, Munich (DE)

(72) Inventor: Gabor BARATH, Taksony (HU)

(21) Appl. No.: 18/700,514

(22) PCT Filed: Oct. 11, 2022
(86) PCT No.: PCT/EP2022/078241

§ 371 Date: Apr. 11, 2024

(30) Foreign Application Priority Data
Oct. 13, 2021 (EP) 21202472.2

(51) Int. Cl. B60T 13/74; H01M 10/0525; H01M 10/42; H02J 7/00

(52) U.S. Cl. CPC B60T 13/746; H01M 10/0525; H01M 10/4264; H02J 7/0068; H01M 2220/20

(57) ABSTRACT

A method for releasing electromechanical brakes, a mobile energy storage device for releasing electromechanical brakes, and a system of the mobile energy storage device and a brake system of a train. A method and a mobile energy storage device for releasing electromechanical brakes, and a system of the mobile energy storage device and a brake system of a train are disclosed. The brakes are released by respectively assigned electromechanical brake actuators, wherein the method includes successively connecting the brake actuators to the mobile energy storage device supplying electrical energy for releasing the brakes; and releasing the brakes by actuating the brake actuators using the energy from the mobile energy storage device.

### PRIORITY AND CROSS REFERENCE

This patent application is a U.S. National Phase of International Patent Application No. PCT/EP2022/078241 filed Oct. 11, 2022, which claims priority to European Patent Application No. 21202482.2, the disclosure of which being incorporated herein by reference in their entireties.

### FIELD

Disclosed embodiments relate to a method for releasing electromechanical brakes, a mobile energy storage device for releasing electromechanical brakes, in particular, for supplying electromechanical brake actuators, and a system of the mobile energy storage device and a brake system of a train, in particular for releasing the electromechanical brakes of the brake system in case of failure of the power supply of the train.

### BACKGROUND

In order to provide braking, electromechanical brakes are provided with electromechanical brake actuators comprising a motor, sensors and electronics to enable provision of a brake force. Due to the use of the electromechanical brake actuators, in case of a failure of power supply of the train, the brakes are active and, therefore, locked, and cannot be released because the internal components, as, e.g., the motor and electronics, do not work without electricity.

However, for example, during a rescue situation in which the train is to be towed by a rescue train, the brakes are to be released.

One option for releasing the brakes would be a disassembling of the actuators from the individual brakes one by one; however, this would cause a great effort since a train can include a large number of brakes. Another option would be that all of the actuators are released simultaneously by providing the brake system with energy; however, this would require supplying a large amount of energy with high peak current into the system which, in turn, would require a large and heavy energy storage device and a bigger cabling complexity of cars of the train.

### SUMMARY

Therefore, disclosed embodiments remedy the above disadvantages by providing a suitable possibility for releasing the electromechanical brakes in case of failure of the power supply of the train without increasing the mass and the costs of the train and the effort for releasing the brakes.

### BRIEF DESCRIPTION OF THE FIGURES

Embodiments are elucidated referring to the drawings. In particular:

FIG. 1 shows a diagrammatic illustration of a system including an energy storage device and brake system of a train, which brake system is provided with brake actuator groups;

FIG. 2 shows a diagram illustrating a speed profile and an energy consumption at a low speed of an actuator;

FIG. 3 shows a diagram illustrating a speed profile and an energy consumption at an optimized speed of an actuator; and

FIG. 4 shows a flowchart of a method for releasing electromechanical brakes of the train.

### DETAILED DESCRIPTION

According to at least one disclosed embodiment, a method for releasing electromechanical brakes by respectively assigned electromechanical brake actuators includes successively connecting the brake actuators to a mobile energy storage device supplying electrical energy for releasing the brakes, and releasing the brakes by actuating the brake actuators using the energy from the mobile energy storage device.

When using a mobile energy storage device for the release of the brakes, no disassembling of the actuators is necessary and the additional equipment of the train is limited to a connector device for connecting the mobile energy storage device to the actuators without requiring a larger cabling complexity of the cars or an additional large energy storage device on the train.

In an advantageous implementation of the method, the brake actuators are operated according to an empirically determined speed profile in which the total energy consumption of the brake actuators during the release time of the brakes is minimized to enable an energy-saving release of the brakes.

By this measure, the actuators are operated according to a speed profile with the lowest energy consumption and, therefore, the amount of the necessary energy and, therefore, of the charging capacity of the energy storage device is reduced which enables a smaller and lighter energy storage device.

In a further implementation of the method, the brake actuators are grouped into a plurality of brake actuator groups, and the brake actuator groups are successively, individually supplied by the mobile energy storage device.

Due to this measure, the energy required simultaneously for releasing the brakes is reduced since a reduced number of brake actuators are to be operated for releasing the brakes at the same time. Therefore, also, the charging capacity of the mobile energy storage device can be reduced and, therefore, the costs therefore are reduced and the handling is facilitated due to a reduced size and weight.

In a further implementation of the method, it includes charging a first energy storage component of the energy storage device by energy stored in a second energy storage component of the energy storage device, and supplying the brake actuators with energy stored in the first energy storage component.

When using the two energy storage components, the individual energy storage components can be optimized, namely, on the one hand, the second energy storage device for holding a large energy capacity for providing energy for a large number of release operations and, on the other hand, the first energy storage device for providing a sufficient current peak value for enabling a requested speed of the actuators.

In a further implementation of the method, the first energy storage component is a capacitor and the second energy storage component is a battery, and the first energy storage component is charged via a charger and booster for controlling charging of the first energy storage component.

The battery provides an advantageous relationship between charging capacity and weight and size. Due to the charger and booster, the discharging of the battery can be optimized, particularly concerning time for discharging the second energy storage component and, therefore, for charging the capacitor. If the battery is discharged slowly while considering the time between the individual release operations, it is possible to use a battery with less weight which reduces costs and enhances handling of the energy storage component. The booster in the form of a voltage level booster is necessary for discharging the maximum energy from the battery and for achieving the best operating voltage for the actuators.

By a further implementation of the method, the brake actuators are supplied via a discharge limiter of the energy storage device.

The use of the discharge limiter protects the energy storage device since it ensures a safe operation range of the first energy storage component.

According to a further implementation, a mobile energy storage device for supplying electromechanical brake actuators for releasing electromechanical brakes comprises a first energy storage component and a second energy storage component, wherein the second energy storage component is configured to charge the first second energy storage component, and the first energy storage component is configured to supply the brake actuators with energy.

When using the two energy storage components, the individual energy storage components can be optimized, on the one hand, the second energy storage device for comprising a large energy capacity for providing energy for a plurality of release operations and, on the other hand, the first energy storage device for providing a sufficient current peak value for enabling a requested speed of the actuators, whereby, the dimensions and the weight of the energy storage device can be optimized.

In an implementation of the mobile energy storage device, the first energy storage component is a capacitor and the second energy storage component is a battery.

The use of the capacitor as the first energy storage component and of the battery as the second energy storage component enables optimization of the energy storage component in view of the provision of the energy in a sufficient amount having a suitable parameters while optimizing dimensions and weight of the energy storage device.

In a further advantageous implementation of the mobile energy storage device, the battery is one of a Lithium-ion accumulator, a NIMH accumulator and a lead acid accumulator.

These types of batteries enable an advantageous relationship between the charging capacity and the weight and size of the batteries.

Due to a further implementation of the mobile energy storage device, it further includes a charger and booster configured to control charging of the first energy storage component. Due to the charger and booster, the discharging of the second energy storage component and, therefore, the charging of the first energy storage component can be optimized, particularly concerning time for discharging the second energy storage component.

In a further implementation of the mobile energy storage device, it further includes a discharge limiter configured to control a supply current supplying the brake actuators. The provision of the discharge limiter protects the energy storage device since it ensures a safe operation range of the first energy storage component.

In a further implementation of the mobile energy storage device, it is configured to be portable. This characteristic enables a facilitated use of the energy storage device since, in case of a plurality of actuator groups spread along a train, it enables an easy transport from one actuator group to the next actuator group for releasing the respective brake actuators.

According to various disclosed embodiments, a system of a mobile energy storage device and a brake system of a train includes a plurality of electromechanical brakes provided with brake actuators grouped into a plurality of brake actuator groups, wherein the brake actuator groups are configured such that brake actuators of the brakes of one of the brake actuator groups are connectable to the energy storage device by one connector device.

In such a system, no disassembling of the actuators is necessary and the additional equipment of the train is limited to a connector device for connecting the mobile energy storage device to the actuators without requiring a larger cabling complexity of the cars or an additional large energy storage device on the train.

In an advantages implementation of the system, the brake actuators are configured to have a reduced energy consumption during release of the brakes by an empirically determined optimized speed profile of the brake actuators.

Due to the optimized speed profile, the actuators are operated according to a speed profile with the lowest energy consumption and, therefore, the amount of the necessary energy and, therefore, of the charging capacity of the energy storage device is reduced which enables a smaller and lighter energy storage device and, therefore, the costs therefore are reduced and a handling is facilitated.

According to a further disclosed embodiment, a computer program product having a program code, stored on a machine-readable carrier, for performing the method is provided.

Subsequently, the disclosed embodiments are elucidated with reference to the drawings.

FIG. 1 shows a diagrammatic illustration of a system 1 including a mobile energy storage device 2 and a brake system 3 of a train. The brake system 3 comprises electromechanical brakes (not shown) and brake actuators 4 assigned to respective electromechanical brakes.

In the present embodiment, four brake actuators 4 are respectively grouped into brake actuator groups 5. The brake actuators 4 of the brake actuator groups 5 are connectable to the energy storage device 2 by cables 6 and a connector device (not shown). In alternative embodiments, another quantity of the brake actuators 4 are grouped into the brake actuator groups 5 or the brake actuators 4 are not grouped into brake actuator groups 5 but the brake actuators 4 are individually connected to the mobile energy storage device 2.

An energy consumption of the brake actuators 4 is reduced by determining an optimized speed profile of the brake actuators 4.

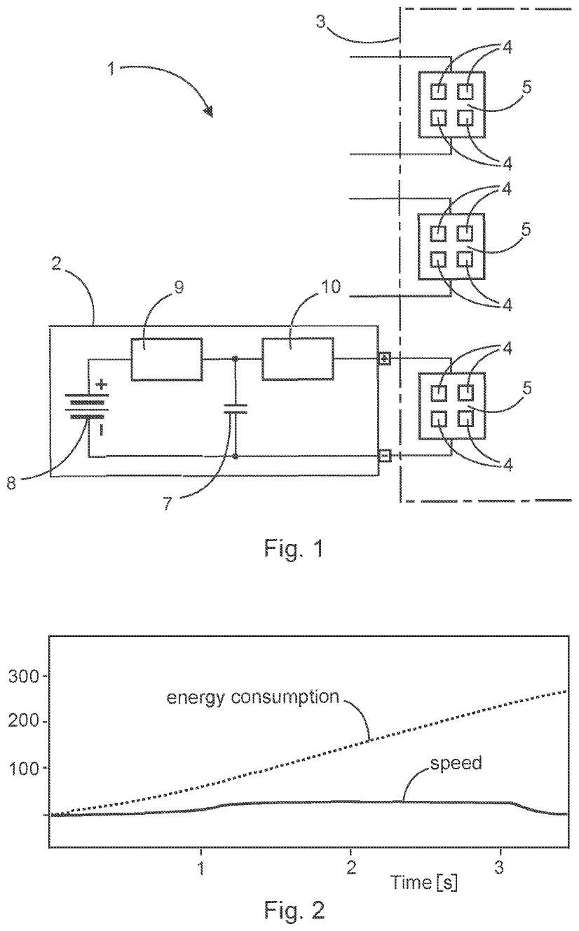

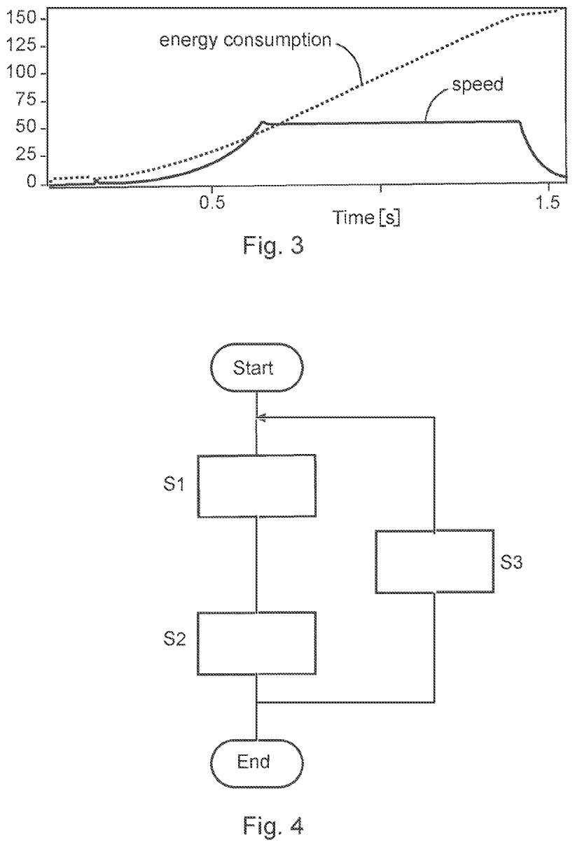

FIG. 2 shows a diagram illustrating a speed profile and an energy consumption of one of the brake actuators 4 at a low speed. On the abscissa of the diagram, the elapsed time is indicated in [s] and, on the ordinate, the speed is indicated in [rad/s] and the energy consumption is indicated in [J]. FIG. 3 shows a diagram illustrating a speed profile and an energy consumption of one of the brake actuators 4 at an optimized speed. Also in this diagram, on the abscissa of the diagram, the elapsed time is indicated in [s] and, on the ordinate, the speed is indicated in [rad/s] and the energy consumption is indicated in [J].

As to been seen from FIG. 2, the maximum speed of the actuator 4 is 20 rad/s and a duration of one release procedure is about 3 seconds. In this case, an energy consumption of 260 kJ for one release procedure results. FIG. 3 shows that at the maximum speed of the actuator 4 is 50 rad/s and at a duration of the one release procedure of about 1.4 seconds, and an energy consumption of the actuator 4 of 155 J for one release procedure results.

Therefore, for having a reduced energy consumption during release of the brakes, an optimized speed profile is to be determined by empirical tests. According to the results of the present investigations, the speed profile is to be designed such that the speed of the brake actuators 4 is to be high in order to reduce operating time of the brake actuators 4. Due to the reduced operating time, in spite of a higher current, the consumed energy for releasing the brakes is reduced compared to brake actuators 4 having a low speed and an increased operating time.

The energy storage device 2 provides energy for actuating the electromechanical brake actuators for releasing the brakes of the train in case of a failure of the power supply of the train.

The mobile energy storage device 2 shown in FIG. 1 comprises a first energy storage component 7 and a second energy storage component 8. The second energy storage component 8 is configured to charge the first energy storage component 7 and the first energy storage component is configured to then supply the brake actuators 4 with energy. The mobile energy storage device 2 is configured to be portable, nevertheless, in alternative embodiments, it is provided, e.g., with castors for being movable.

The first energy storage component 7 is formed by a capacitor, in particular, by a capacitor bank using Super/Ultra capacitor technology which farther reduces the weight of the first energy storage component 7. In alternative embodiments, the first energy storage component 7 can also be formed by another kind of energy storage components providing suitable operating properties.

The second energy storage component 8 is formed by a battery, in particular, by a Lithium-ion accumulator. In alternative embodiments, the second energy storage component 8 can be formed of a NIMH accumulator, a lead acid accumulator or another suitable kind of battery.

The capacitor bank being the first energy storage component 7 and the battery being the second energy storage component 8 provide the following advantages. The battery has an advantageous relationship between charging capacity and weight and size so that a larger amount of energy for a plurality of releasing procedures can be stored without excessively increasing size and weight of the mobile energy storage device. However, the battery cannot provide a high peak current which is necessary for achieving a high speed of the actuators 4. Therefore, the capacitor bank which has a small charging capacity, however, sufficient for one releasing procedure, is used for providing the high peak current without the need of a large charging capacity since it can be charged by the battery after each releasing procedure.

The mobile energy storage device 2 further comprises a charger and booster 9 and a discharge limiter 10.

The charger and booster 9 controls charging of the first energy storage component 7. The charger and booster 9 enables charging the first energy storage component 7 with energy by discharging the second energy storage component 8 in an optimized manner. The discharging of the second energy storage component 8 is performed as slowly as possible so that a battery having less weight can be used, nevertheless, keeping in mind that the first energy storage component 7 is to be charged completely after being disconnected from the last actuator group 5 before being connected to a next actuator group 5. In particular, the booster enables discharging of the maximum energy from the battery and achieving the best operating voltage for the actuators 4.

The discharge limiter 10 is configured to control and to limit a supply current supplying the brake actuators 4. Therefore, the discharge limiter 10 ensures a safe operation range of the capacitor bank and, therefore, it protects the energy storage device 2.

FIG. 4 shows a flowchart of a method for releasing electromechanical brakes of the brake system 3 of the train.

In use, when a failure of the power supply of the train occurs, however, the train has to be moved, for example, into a next station, the electromechanical brakes of the brake system 3 of the train have to be released by the respectively assigned brake actuators 4. The following procedure can be executed under the premise that the second energy storage component 8 is sufficiently charged.

In operation S1, the brake actuators 4, particularly when grouped into the actuator groups 5, the actuator groups 5, are successively connected to the mobile energy storage device 2 supplying electrical energy for releasing the brakes. This connecting procedure are performed by connecting a connector device having two connector components, one being joined to the mobile energy storage device 2 and the other one being joined to the brake actuators 4.

In operation S2, the brake actuators 4 supplied with energy from the mobile energy storage device 2 are actuated and, thereby, the brakes being in a locked state are released since the brake actuators 4 are supplied with energy stored in the first energy storage component 7 of the mobile energy storage device. The brake actuators 4 are actuated by a switch included in the mobile energy storage device 2. Alternatively, the switch is assigned to the brake actuators 4.

These two operations S1 and S2 are repeated until all of the brakes of the brake system 3 of the train are released and, when all of the brakes of the brake system 3 are released, the train can be moved.

In operation S3, the first energy storage component 7, i.e., the capacitor bank, of the energy storage device 2 is charged by energy stored in the second energy storage component 8, i.e., the Lithium-ion accumulator, of the energy storage device 2. If the energy storage device 2 has another structure, an energy storage component supplying the brake actuators 4 with energy can be charged in another manner as long as the sufficient amount of energy is available.

The capacitor bank is charged via the charger and booster 9 such that the charging of the first energy storage component 7 is controlled by the charger and booster 9. If, in alternative embodiments, the charge and booster 9 is not available, charging of the first energy storage component 7 is controlled by other electronics.

The supply of the brake actuators 4 is performed via the discharge limiter 10 of the energy storage device 2 and, thereby, the discharge limiter 10 ensures a safe operation range of the capacitor bank, whereby, it protects the energy storage device 2. If, in an alternative embodiment, the discharge limiter 10 is not available, the energy storage device 2 is protected in another manner or the protection is omitted.

The method is performed by a computer program product stored on a machine-readable carrier. Alternatively, the method is performed in another suitable manner, e.g., by a hardwired device.

Although the disclosed embodiments have been described with reference to specific features and embodiment details thereof, it is evident that various modifications and combinations can be made thereto without departing from the spirit and scope of the invention. The specification and drawings are, accordingly, to be regarded simply as an illustration of the invention as defined by the appended claims, and are contemplated to cover any and all modifications, variations combinations or equivalents that fall within the scope of the present invention.

### LIST OF REFERENCE SIGNS

1 system
2 mobile energy storage device
3 brake system
4 brake actuator
5 brake actuator group
6 cable
7 first energy storage component
8 second energy storage component
9 charger and booster
10 discharge limiter

1. A method for releasing electromechanical brakes by respectively assigned electromechanical brake actuators, the method comprising:
successively connecting the brake actuators to a mobile energy storage device supplying electrical energy for releasing the brakes; and
releasing the brakes by actuating the brake actuators using the energy from the mobile energy storage device.

2. The method of claim 1, wherein the brake actuators are operated according to an empirically determined speed profile in which the total energy consumption of the brake actuators during the release time of the brakes is minimized to enable an energy-saving release of the brakes.

3. The method of claim 1, wherein
the brake actuators are grouped into a plurality of brake actuator groups, and
the brake actuator groups are successively, individually supplied with energy by the mobile energy storage device.

4. The method of claim 1, further comprising:
charging a first energy storage component of the energy storage device by energy stored in a second energy storage component of the energy storage device; and
supplying the brake actuators with energy stored in the first energy storage component.

5. The method of claim 4, wherein
the first energy storage component is a capacitor and the second energy storage component is a battery, and the first energy storage component is charged via a charger and booster for controlling charging of the first energy storage component.

6. The method of claim 4, wherein the brake actuators are supplied via a discharge limiter of the energy storage device.

7. A mobile energy storage device for supplying electromechanical brake actuators for releasing electromechanical brakes, the device comprising:
a first energy storage component; and
a second energy storage component, wherein
the second energy storage component is configured to charge the first energy storage component, and
the first energy storage component is configured to supply the brake actuators with energy.

8. The mobile energy storage device of claim 7, wherein the first energy storage component is a capacitor, and the second energy storage component is a battery.

9. The mobile energy storage device of claim 8, wherein the battery one of a Lithium-ion accumulator, a NIMH accumulator and a lead acid accumulator.

10. The mobile energy storage device of claim 7, further comprising a charger and booster configured to control charging of the first energy storage component.

11. The mobile energy storage device of claim 7, further comprising a discharge limiter configured to control a supply current supplying the brake actuators.

12. The mobile energy storage device of claim 7, wherein the mobile energy storage device is configured to be portable.

13. A system comprising:
the mobile energy storage device of claim 7; and
a train brake system including a plurality of electromechanical brakes provided with brake actuators grouped into several brake actuator groups,
wherein the brake actuator groups are configured such that brake actuators of one of the brake actuator groups are connectable to the energy storage device by one connector device.

14. The system of claim 13, wherein the brake actuators are configured to have a reduced energy consumption during release of the brakes by an empirically determined optimized speed profile of the brake actuators.

15. A non-transitory computer program product having a program code, stored thereon, for performing the method of claim 1.
